(19) United States
(12) Patent Application Publication
(10) Pub. No.: US 2014/0296751 A1
(43) Pub. Date: Oct. 2, 2014

(54) APPARATUS AND METHOD OF BODY CONTOURING AND SKIN CONDITIONING

(71) Applicant: Diamond Medical Aesthetics Pty Ltd, Newton (AU)

(72) Inventor: Ronald Allan Greenberg, Newton (AU)

(21) Appl. No.: 14/358,130

(22) PCT Filed: Nov. 14, 2012
(86) PCT No.: PCT/AU2012/001400

§ 371 Date: May 14, 2014

(30) Foreign Application Priority Data
Nov. 14, 2011 (AU) 2011904728

(51) Int. Cl. A61H 7/00

(52) U.S. Cl. CPC A61H 7/00
USPC 601/6

(57) ABSTRACT

An improved apparatus and method of body contouring and skin conditioning for the treatment of conditions such as lymphoedema by producing vibrations in the subcutaneous layers of fat. The apparatus includes a cup which engages the patient's skin surface and a vacuum source which provides suction and a pulsating movement against the skin's surface, mimicking the movement of the lymphatic system and flushing out toxins, fat layers and trapped fluid from the area.

### FIELD OF THE INVENTION

This invention relates to an improved apparatus and method of body contouring and skin conditioning for treating conditions such as lymphoedema.

### BACKGROUND TO THE INVENTION

The lymphatic system consists of lymph vessels, lymph nodes and lymphoid tissues and is a secondary system within the circulatory system that removes waste. The lymphatic system works according to a one-way principle and is a drainage system to drain away lymph which continually escapes from the blood in small amounts. The lymph is first collected at the lymph capillaries, which in turn drain into larger vessels. The lymph is pumped in and out of these vessels by movements of adjacent muscles and by contractions of the walls of the larger vessels, move through the lymphatic system in one direction. Foreign matter and bacteria are filtered at various lymph node groups after which the fluid empties into the venous portion of the blood system, mainly through the thoracic duct. A healthy person will drain one to two litres of lymph fluid through this duct every 24 hours.

The accumulation of fluid in the tissues manifests in a range of disorders or diseases including heart problems, inflammations associated with arthritis and infection, renal disorders and lymphoedema. The accumulation of the watery fluid in the body which causes lymphoedema results in the swelling of the body in the affected area, causing pain and discomfort. Lympheodema often occurs after surgery or radiation therapy, most notably through the damage to the lymphatic system or removal of the lymph glands due to cancer treatment.

The current basis for the treatment of lymphoedema is compression therapy, such as the use of compression bandages and/or garments or lymphatic massage. Such bandages, however do not actually assist in moving or draining the fluid and can be uncomfortable. Massage is time-consuming and labour intensive and often does not provide the pressure needed to drain fluid. Surgical methods such as liposuction are also known, however such procedures can be invasive and does not prevent future build up of toxins or fat.

The object of this invention is to provide a treatment for lymphoedema which alleviates the above problems or at least provides the public with a useful alternative.

### SUMMARY OF THE INVENTION

Therefore, according to one aspect, the present invention provides an apparatus and method of body contouring and skin conditioning including: a pressure differential device adapted to produce a pressure differential; at least one cup having at least a first and second opening, wherein said first opening is defined by a perimeter, which when placed against a skin surface defines a chamber, and said second opening is in communication therethrough with said pressure differential device, whereby operation of said pressure differential device causes an oscillating pressure is produced within said chamber which causes said skin to vibrate; and wherein the pressure differential device is operable to produce pressure oscillations at a selectable frequency.

In an embodiment, said frequency is selectable through use of a switch associated with the pressure differential device wherein the frequency can be alternated from “slow” and “fast” settings.

In an embodiment, said “fast” setting reflects a frequency of approximately 300 pulses per minute and is adapted for superficial treatment of the skin.

In an embodiment, said “slow” setting reflects a frequency of approximately 200 pulses per minute and is adapted for deeper treatment of the skin; and

In an embodiment, said pressure differential device is adapted for the treatment of medical conditions such as lymphoedema.

In a second aspect, the present invention provides a method of body contouring and skin conditioning using a suction device having a plurality of cups and a pressure differential device configured to produce a pressure differential, the method characterized by the steps of: placing said plurality of cups onto a skin surface, whereby an opening of each said cup contacts the skin surface thereby defining a chamber; operating the pressure differential device to create an oscillating pressure within said chamber thereby causing tissue layers to vibrate; and controlling the frequency of the pressure oscillations by selecting a frequency of the oscillations.

In an embodiment, said frequency is selectable through use of a switch associated with the pressure differential device wherein the frequency can be alternated from “slow” and “fast” settings.

In an embodiment, said “fast” setting reflects a frequency of approximately 300 pulses per minute and is adapted for superficial treatment of the skin.

In an embodiment, said “slow” setting reflects a frequency of approximately 200 pulses per minute and is adapted for deeper treatment of the skin; and

In an embodiment, said pressure differential device is adapted for the treatment of medical conditions such as lymphoedema.

### BRIEF DESCRIPTION OF THE DRAWINGS

The accompanying drawings, which are incorporated in and constitute a part of this specification, illustrate various implementations of the invention and, together with the description, serve to explain the advantages and principles of the invention. In the drawings:

FIG. 1 is a perspective view illustrating an apparatus for contouring and skin conditioning having a plurality of treatment devices;

FIG. 2 is a side cut away view of one of the treatment devices of FIG. 1;

FIG. 3 is a side cut away view of a second embodiment of an apparatus for contouring and skin conditioning;

FIG. 4 is a side cut away view of a third embodiment of an apparatus for contouring and skin conditioning;

FIG. 5 is a perspective view of a fourth embodiment of an apparatus for contouring and skin conditioning;

FIG. 6 is a side cut away view of one of the treatment devices of FIG. 1 illustrating how the apparatus produces vibrations in the subcutaneous fat layer;

FIG. 7 is a perspective view of a fifth embodiment of an apparatus for contouring and skin conditioning;

FIG. 8 is a front view of the control panel of FIG. 7;

FIG. 9 is a perspective view of a handpiece of FIG. 7 illustrating a large cup;

FIG. 10 is a perspective view of a handpiece of FIG. 7 illustrating a small cup;

FIG. 11 is a schematic view of the compressor and suction device of the apparatus of FIG. 7;

FIG. 12 is a schematic view illustrating an alternate arrangement of the compressor and suction device of the apparatus of FIG. 7;

FIG. 13 is a rear view of the apparatus of FIG. 7; and

FIG. 14 is a perspective view of the apparatus of FIG. 7 illustrating the use of additional treatment devices.

### DETAILED DESCRIPTION OF THE EMBODIMENT(S)

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The outermost layer of the skin is referred to as the epidermis. Below the epidermis is the dermis, which contains hair follicles, sweat glands, blood vessels, nerve receptors and connective tissue. Underneath the dermis are the first three layers of subcutaneous fat, the uppermost layer of which has been described as “standing fat cell chambers” separated by connective tissue. Water retention and fat build up in the adipose tissue provides insulation and is divided into lobes by small blood vessels. The cells of this layer are adipocytes which are specialised in storing energy as fat.

Chronic lymphoedema is caused by a high content of adipose tissue, due to the decreased or removed lymph transport and the resulting water stagnation and fluid inflammation, causing swelling. This causes discomfort to the individual as the fluid and fat are not properly drained away by the lymphatic system.

The invention is therefore directed to an apparatus and method for the breakdown of both the superficial blockages as well as deeper fat layers to allow fluid to be flushed out of the body. The invention is designed to act as a mimic to the lymphatic system; a tool for moving the whole of the lymph, or otherwise an extension of the lymphatic system to encourage the drainage of the retained fluid and fat.

In the working of the lymphatic system there is a continual process of peristalsis every time there is muscular movement and this peristalsis assist is the strong movement of lymphatic flow. The dermis effectively contains the tributaries leading to the lymphatic system and while mild peristalsis is possible within the tributaries, by using the invention one is effectively creating a one way valve and with strong pressure created by the pulsing of the invention.

This strong pressure in turn creates a peristalsis type action within the tributary system in the dermis and effectively allows it to mimic the lymphatic system movements and thereby assists in the removal of blockages to assist it to flow into the lymphatic system and to be removed as waste.

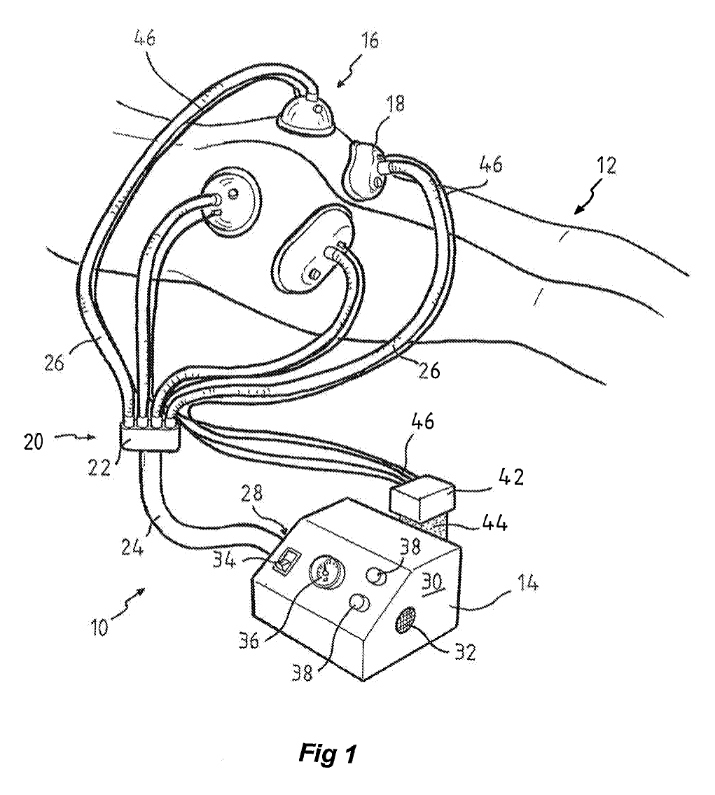

Illustrated in FIG. 1 is an apparatus 10 for the treatment of a patient 12. It is to be understood that while the preferred embodiment of the invention is the treatment of lympheodema, the invention can be adapted for other uses, both medical and non-medical.

The apparatus 10 includes a vacuum/compressor source 14 and a plurality of handpieces 16, each of which may include a cup 18 or other device adapted to engage the surface of a patient's body 12. The handpieces 16 are connected to the vacuum/compressor source 14 via connection means 20. As illustrated in FIG. 1, the connection means 20 may include an intermediary multiple adaptor 22 that connects a primary tube 24 to a series of secondary tubes 26. The primary tube 24 is connected to the inlet 28 of the vacuum/compressor source 14, while the secondary tubes 26 are connected to handpieces 16. The reader should however appreciate that each cup may be individually connected to the vacuum/compressor source 14 via a separate tube (not shown).

As clearly illustrated in FIG. 1, several cups 18 can be placed in different locations on the patient 12 during treatment. This enables the time of treatment to be reduced and ensures that problem areas are targeted by leaving the relevant cup 18 in place for longer. The present method also ensures that sensitive areas are not treated for extended periods of time which may result in skin irritation or bruising. Alternatively the cups 18 can be applied manually by the user.

The vacuum source 14 includes a housing 30, an aperture 28 connected to tube 24, a vent 32, a switch 34 adapted to operate vacuum/compressor source 14, a gauge 36 adapted to measure the pressure differential produced by vacuum/compressor source 14, and control valves 38 adapted to alter the strength and frequency of the pressure differential produced by the vacuum/compressor source 14 during operation. The reader should appreciate that the vacuum/compressor source 14 may be connected to mains power or may have an enclosed battery to provide greater portability. Although we refer to a vacuum/compressor source 14 any device may indeed be used to create a pressure differential.

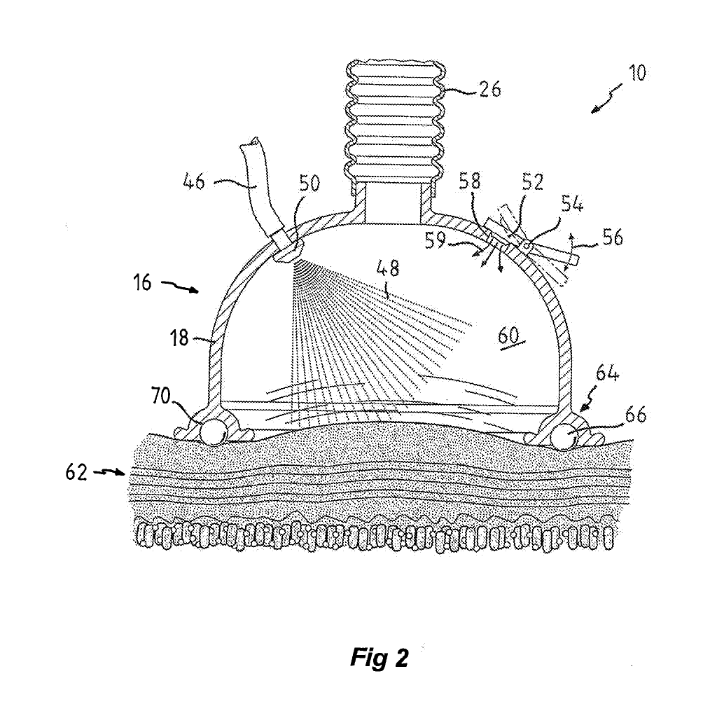

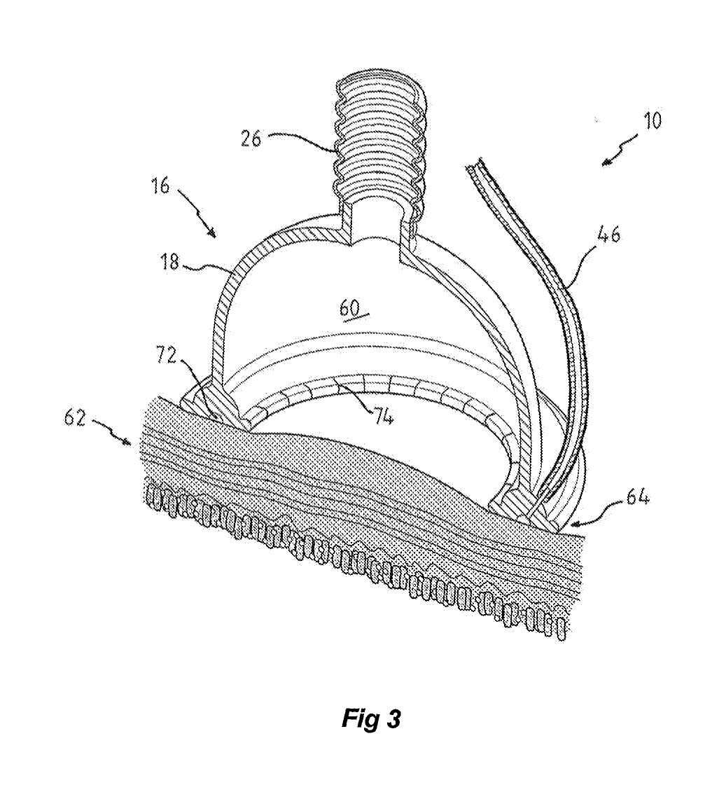

The apparatus 10 may further include a supply container 42 that contains a therapeutic substance or substances 44. The supply container 42 is connected to the handpieces 16 via tubes 46. In this way the therapeutic substances 44 are drawn 30 out of the supply container 42 by the vacuum produced by the vacuum/compressor source 14. It should however be appreciated by the reader that the apparatus 10 may include a motorised dispelling means (not shown) that disseminates the therapeutic substances 44 within the handpieces 16. In this way, as illustrated in FIG. 2, jets 48 of substance 44 may be sprayed from an outlet 50 onto the patient 12 during operation of the apparatus 10.

Therefore, the invention discloses the use of a apparatus in which a cup 18 engages the skin surface of the patient 12 and a vacuum source 14 provides suction and a pulsating movement against the skin surface. This mimics the movement of the lymphatic system and creates peristaltic muscle movement. This is an encouragement of the natural muscle movement of the body, which breaks up the toxins, fat layers and trapped fluid and flushes it through the patient's system to exist as waste.

While it is a preferred embodiment of the invention that the apparatus be used to treat lymphoedema and flush out accumulated or stagnant fluid, it is to be understood that it has other cosmetic applications, such as the flushing out of fat and toxins from a patient's body.

As further illustrated in FIG. 2, the cup 18 may include a release valve 52 that is adapted to pivot at hinge 54 when pressure is applied to the release valve 52 in the direction of arrow 56. In this way aperture 58 is exposed which allows atmospheric air to enter the cup 18 in the direction of arrows 59 thereby equalising the pressure within chamber 60 with the atmospheric pressure. The chamber 60 is formed when the cup 18 is placed against the surface of the skin 62. The release valve 52 enables the cup 18 to be removed from the surface of the skin 62. The perimeter 64 of the cup 18 may further include a rubber washer 66 housed within a channel 70 which acts to seal the chamber 60. The sealing means 66 ensures that the entire perimeter 64 of the cup 18 engages the surface of the skin 62, ensuring that a pressure differential is produced within the chamber 60 even when the cup 18 is placed on an uneven surface.

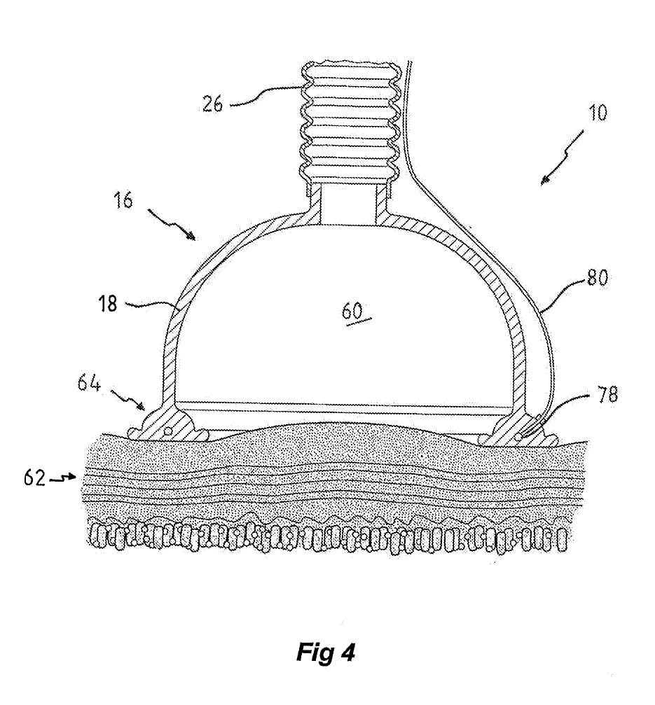

As illustrated in FIG. 4, the handpiece 16 may include a temperature regulator 78 adapted to affect the temperature of the skin 62. The temperature regulator 78 is connected to a power source (not shown) via cable 80. The temperature regulator 78, in the form of a heating element, extends around the perimeter 64 of the cup 18 in close proximity to the surface of the skin 62. The temperature regulator 78 heats the cup 18 which in turn heats the air contained within the chamber 60. However, the reader should appreciate that the invention is not limited to a heating element. The temperature regulator 78 may alternatively be configured to lower the temperature of the skin 62. For instance, cold air could be injected at regular intervals into the chamber 60 in close proximity to the surface of the skin 62.

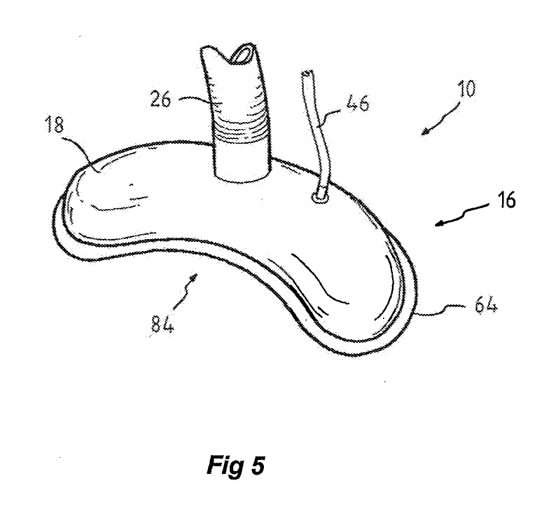

Although larger areas such as thighs and arms are prone to lymphoedema, other smaller areas such as the face and neck may also be affected by water retention and fat build up in the adipose tissue. For this reason, the cups 18 may be of varied shape and size depending upon the area of the patient 12 being treated. For instance, as illustrated is FIG. 5, the cup 18 may be kidney shaped 84 to facilitate the treatment around the temples or on the cheeks. Alternatively, the cup may be cone-shaped or form part of the handpiece itself. The reader will now appreciate that several different shaped cups 18 may be connected to a single vacuum source 14 to facilitate the treatment of a patient 12. Furthermore, there may be various sizes of cups 18 so that the treatment can be tailored to the specific physiological attributes of the patient 12. The reader should appreciate that the diameter of the tubes 26 may be varied or the fluid communication between different tubes 26 and the respective cup 18 may be restricted to provided different strengths of suction and compression for different cups 18. In this way, the cups 18 placed on sensitive areas of the patient's body can have a lower pressure differential.

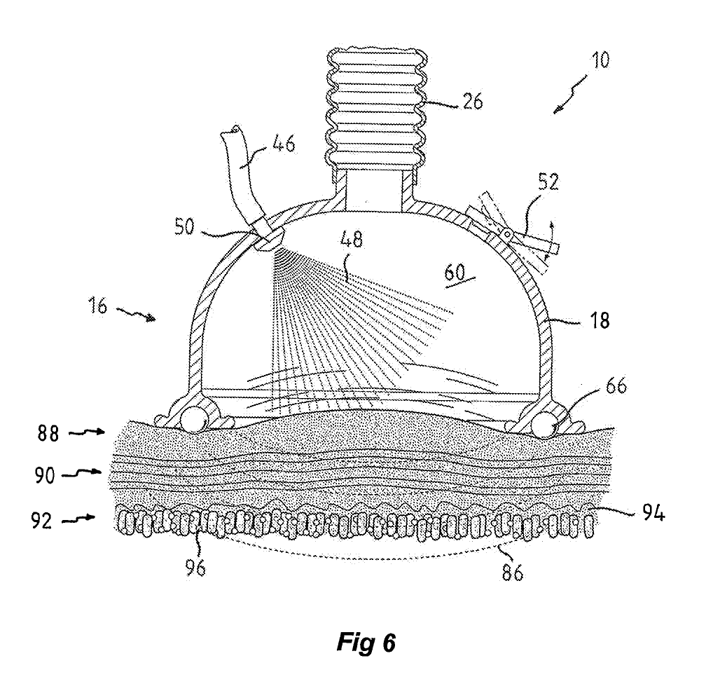

During use of the apparatus 10 the pressure within the chamber 60 is varied by the vacuum source 14. This pulsing of the pressure within the chamber 60 creates vibrations 86, as illustrated by the semicircular perforated lines in FIG. 6. These vibrations 86 pass through upper layers of skin referred to as the epidermis 88 and dermis 90 layers. The vibrations 86 then pass into the subcutaneous fat layer 92. The subcutaneous fat layer 92 contains small projections of fat cells 94 that protrude into the dermis 90 and also result in fluid retention. By causing vibration of the subcutaneous fat layer 92 the apparatus 10 is able to help break apart the clusters of fat cells 94 and release the water molecules 96 held therein. This assists the lymphatic system in draining the excessive fat cells 94 and water 96 from the subcutaneous fat layer 92.

The vibration, or more accurately resonate frequencies, of all matter, whether inorganic and organic, are specific and unique. Each tissue in the human body has individualized frequencies. The resonate frequency of organs such as the heart is around 6Hz while the resonate frequency of skin is around 1 Hz. Fat cells have a different resonate frequency to muscles cells. Therefore, the frequency of vibration may be chosen to be close to the natural frequency of the fat cells thereby amplifying the affect of the apparatus 10. It should be appreciated by the reader that the frequency may be adjusted by use of the control valves 34 adapted to alter the strength and frequency of the vacuum and compression produced by the vacuum/compressor source 14 during operation. It is envisaged that the frequency of vibration within chamber 60 ranges from 10-200 Hz with high frequency vibrations in the range of 1-20 kHz, however, the reader should appreciate that the present invention is not limited to these pressures or frequencies.

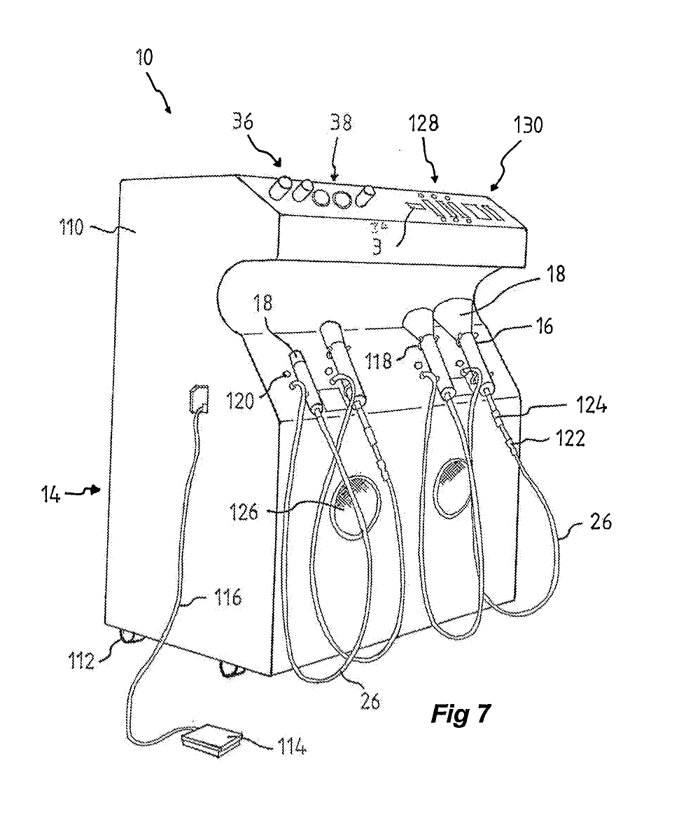

In a preferred embodiment as illustrated in FIG. 7, the apparatus 10 includes a console 110 adapted to house the vacuum/compressor source 14. The console 110 is mounted on legs or rollers 112 to assist in the transportation of the apparatus 10. The apparatus may further include a foot peddle 114, connected to the vacuum/compressor source 14 by way of cable 116, which is adapted to control the operation of the apparatus 10, thereby facilitating ease of use. As illustrated in FIG. 7 the apparatus may include a plurality of mobile handpieces 16 each with different sized cups 18. This ensures that the user does not have to replace the cup 18 every time a different size is required. The handpieces 16 are adapted to engage clips 118 on the front of the console 110. A light 120 corresponding to each mobile handpiece 16 indicates which device or devices are in use.

The tube 22 connected to the vacuum/compressor source 14 includes a venturi tube 122 adapted to regulate the passage of air therethrough and filter 124 to ensure that foreign material such as dirt does not enter the vacuum/compressor source 14 which could cause mechanical failure. The console 110 includes vents 126 to provide ventilation for the vacuum/compressor source 14. An instrument panel 128 is provided at the top of the console 110 and includes an on/off switch 30, gauges 36, control valves 38 and auxiliary switches 130.

The reader should however appreciate that the invention is not limited to the above embodiments regarding the configuration of handpieces, switches and gauges.

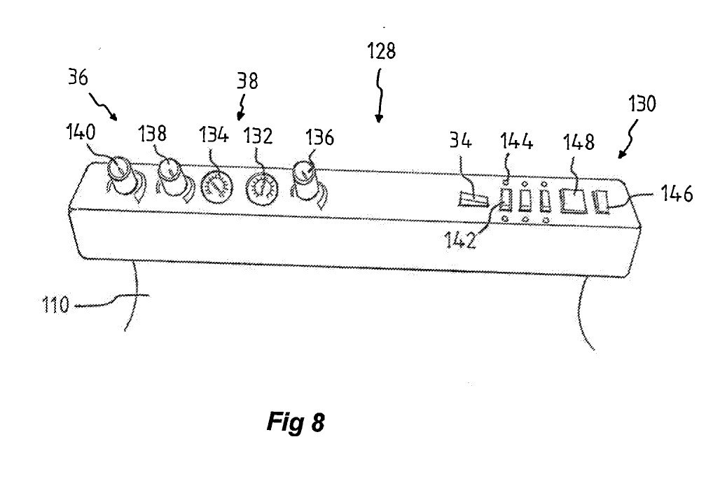

As illustrated in FIG. 8 the control panel 128 includes gauges 132 and 134. Gauge 132 is adapted to measure the compressed air flow produced by source 14, corresponding switch 136 is configured to adjust the compressed air flow. Gauge 134 is configured to measure the vacuum produced by source 14. Corresponding switch 138 is adapted to adjust the production of the vacuum by source 14, while switch 140 is for fine adjustment. The control panel 128 further includes auxiliary switches 130 for controlling the operation of the apparatus 10. The auxiliary switches 130 include selector switches 142, with indicator lights 144, used for selection an individual handpieces 16, switch 146 and display panel 148. The reader should however appreciate that the present invention is not limited to this configuration of switches and gauges.

The apparatus further includes a fast/slow switch (not shown) which limits the frequency of the vibrations to the optimal fast and slow speeds.

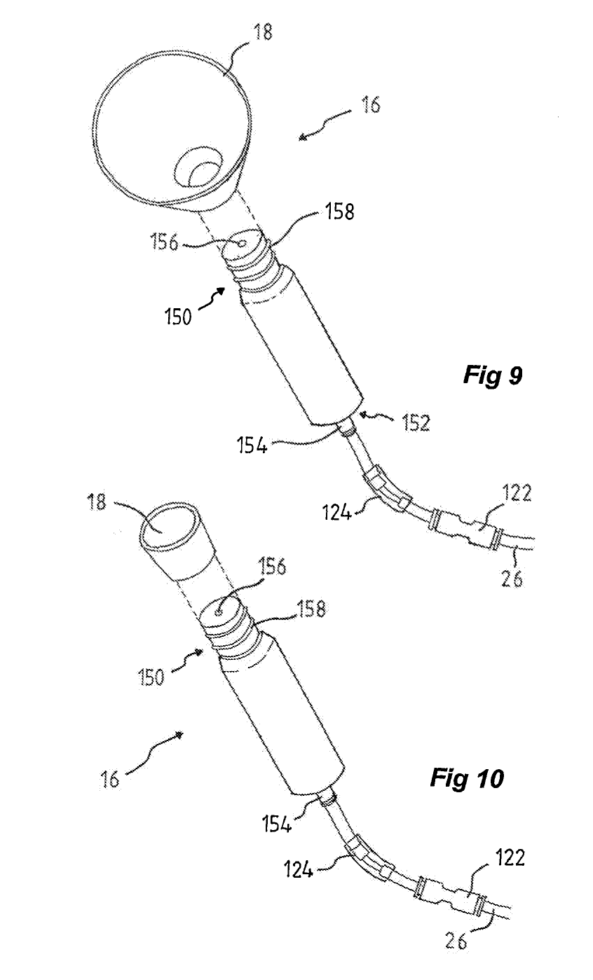

FIGS. 9 and 10 illustrate an individual handpiece 16 engaging different sized cups 18. The handpiece 16 includes a first end 150 adapted to engage a cup 18 and a second end 152 which includes a boss 154 adapted to connect to tube 26. The first end 150 includes an aperture 156 in communication with tube 26 and a series of 0-rings 158. The cup 18 slide-ably engages the first end 150 and is held in place by the frictional force of the 0-rings 158 as is well known in the art.

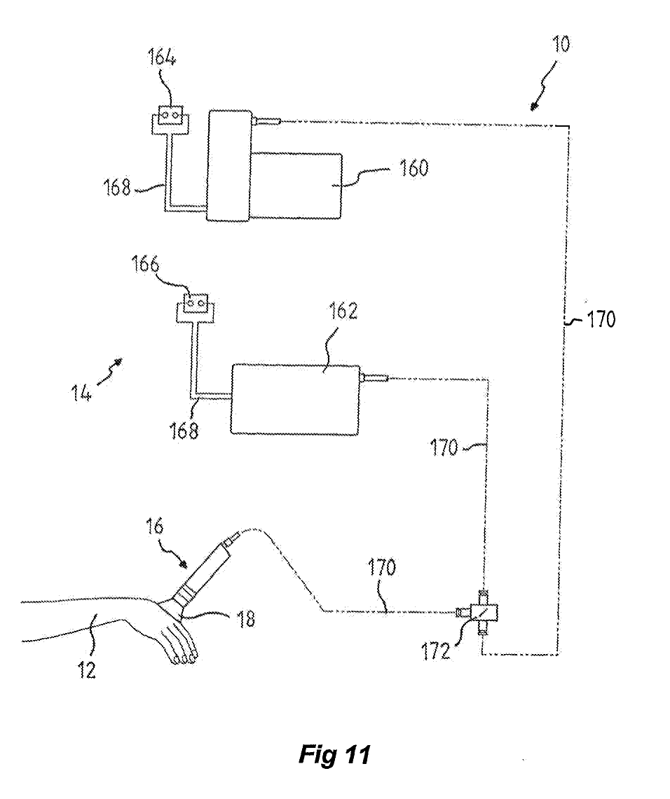

As illustrated in FIG. 11, the vacuum/compressor source 14 includes a vacuum producing device 160 and a compressor 162. The vacuum producing device 160 and compressor 162 are connected to respective power sources 164 and 166 by way of electrical cables 168. The vacuum producing device 160 and compressor 162 are in communication 170 with selector switch 172. The selector switch 172 determines which of the devices 160 or 162 is in communication 170 with the handpiece 16. This produces a cyclic oscillation of the pressure within cup 18, from a higher than atmospheric pressure to a lower than atmospheric pressure.

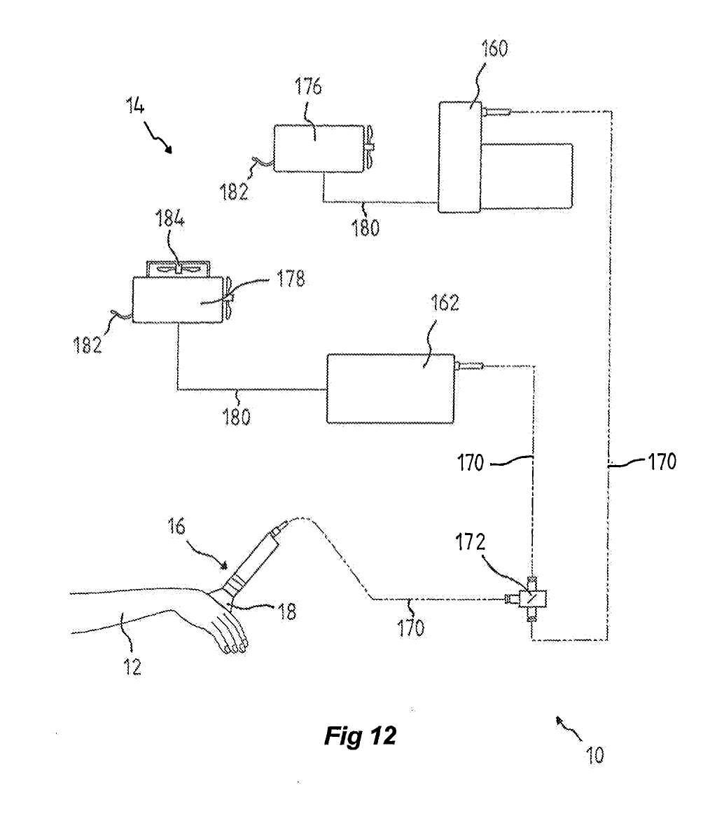

As illustrated in FIG. 12, vacuum producing device 160 and compressor 162 are connected to respective electric motors 176 and 178 by way of cables 180. Motors 176 and 178 are connected to a power source by way of electrical cable 182. The motor 178 corresponding to compressor 162 includes an additional fan 184 to assist in cooling.

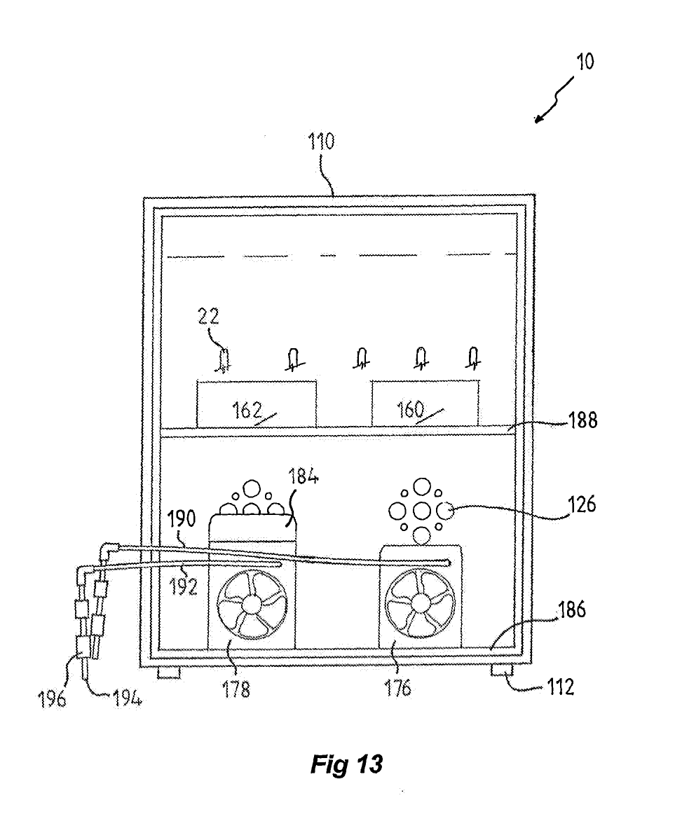

FIG. 13 illustrates the rear of the console 110 with the back panel removed.

The motor 176 and 178 are mounted on the base 186 of the console 110 adjacent to vents 126. The vacuum producing device 160 and compressor 162 are mounted on shelf 188. Inlet tubes 190 and 192 are configured to supply air to vacuum producing device 160 and a compressor 162 respectively, which are in fluid communication with handpiece 16 through pipes 26. The supply tubes 190 and 192 include an opening 194 and filters 196. The apparatus can also include double motors if required.

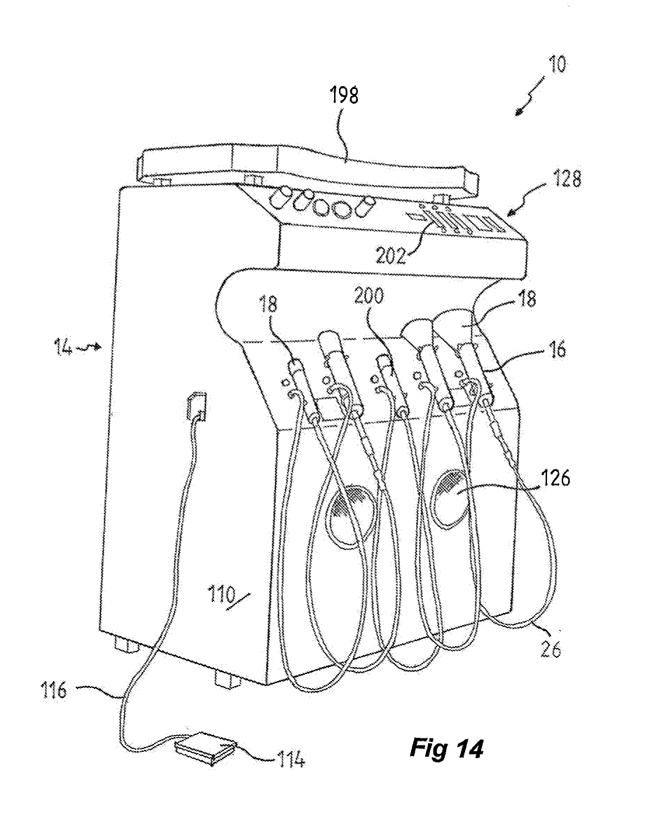

As illustrated in FIG. 14, the apparatus 10 can be used in conjunction with additional treatment devices, including electrical signal applicator 198 and oxygen infusing handpiece 200 which is controlled by switch 202.

It should be appreciated by the reader that the present description provides, by way of example, one arrangement in which the principles of the present invention may be employed. It should however be appreciated that the present invention is not limited to this particular embodiment. It has been described that an air compressor and vacuum source alternately communicate with the cup, however, it should be appreciated that any device could be used to produce a pressure differential. It has also been discussed that the pressure within the cup alternates between two states; one of greater than atmospheric pressure and the other of lower than atmospheric pressure. It should however be appreciated that the pressure within the cup does not need to be lower than atmospheric pressure. The pressure states within the cup 18 could alternate and both be greater than atmospheric pressure.

The present invention is thus an improvement on conventional treatments for lymphoedema such as pressure bandages or massage. Pressure bandages only provide pressure to the affected area and thus only provide short-term relief without treating the blockages of fluid retention. Massage, while it does encourage movement of the muscles, only provides pressure to the affected area and does not create peristalsis nor does it encourage sufficient break-up of toxins, blockages or stagnant fluid. By contrast, the apparatus and the frequency of the vibrations mimic the lymphatic system of the body and thus effectively become an extension of the lymphatic system itself. It encourages the break-up of toxins, stagnant fluid and fats, which pass through the lymphatic systems and exit as waste, thus reducing swelling and discomfort to the patient. Compression does not achieve this, as it merely pushes against the affected area, rather than loosening or breaking up the fat layers, which is needed for it to be drained through the lymphatic system.

The apparatus and vacuum/compressor source 14 works on the same principle as a plunger, in that it causes a sucking or vacuum motion against the surface skin and affecting the fat layers below before releasing or pushing back against the skin. The pull-push movement causes the break-up of the fat layers and fluid, allowing it to be pass through the lymphatic system and exit the body as waste. Thus the toxins, fluid and/or fat is drained away from the affected area and the patient can experience continual improvement over time due to continual drainage.

The improvements of this apparatus on known body contouring and skin conditioning apparatus' of this type relates to the effectiveness of the treatment found by limiting the vibrations to certain speeds or frequencies.

The frequency of the vibrations can be altered to provide different levels of treatment. For example, a fast or high frequency vibrations treat superficial blockages on the surface layers of skin whilst a slower or lower frequency vibration provides deeper treatment and thus breaks down fat in deeper blockages. Thus both speeds drive the flushing of the blockages but at a different depth which is in line with the universal laws of frequency and light whereby the faster the movement or the quicker the light frequency the more superficial it is. An example is ultraviolet light being far more superficial to the body than infra red, and thus the differing speeds of the vibrations act on varying levels of the skin.

The apparatus therefore includes a fast/slow switch which limits the frequency of the vibrations to two settings, fast, being a rate of approximately 300 pulses per minute, and slow, being a rate of approximately 200 pulses per minute. The switch can be set to either setting prior to the application of the vacuum/compressor source 14 and provides controlled vibrations at the optimal frequency for treatment.

Superficial treatment can be achieved by use of the “fast” setting which is effective on sensitive areas of the body such as the face and neck. It can also be used for superficial blockages or as a massage tool. Deeper or more comprehensive treatment can be achieved by use of the “slow” setting which is effective on areas where there are deeper fat layers or where stagnant fluid has solidified over time.

While other frequencies may be used, the set fast/slow settings of the apparatus have been found to create the more effective results in the breakdown of fat and fluid

The apparatus can also be adapted for use with other technologies and techniques, such as ultrasound.

The skilled addressee will now appreciate the many advantages of the present invention for an apparatus and method of body contouring and skin conditioning. The invention provides a non-invasive method for treating lymphoedema that overcomes many of the limitations of currently available treatments. The apparatus 10 provides a treatment that reduces the fluid blockage by assisting the drainage of the lymphatic system with minimal discomfort to the patient. As the reader will now appreciate the use of pulsating pressure within the chamber 78 creates vibrations that pass through into the subcutaneous fat layer. This avoids the use of an aggressive massage of the underlying tissue which can result in such problems as bruising and which is not suitable for some people including those who are pregnant. The present method also means that there is less impact on the operator thereby reducing the risk of repetitive strain injuries. As the reader will now appreciate the present invention provides an exemplary way of treating lymphoedema that is both gentle on the patient and operator and provides effective treatment not provided by other methods.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the summary of the invention, except where the context requires otherwise due to express language or necessary implication, the word “comprising” is used in the sense of “including”, i.e. the features specified may be associated with further features in various embodiments of the invention.

1. An apparatus of body contouring and skin conditioning, said apparatus comprising:
a pressure differential device adapted to produce a pressure differential;
at least one cup having at least a first and second opening, wherein said first opening is defined by a perimeter which when placed against a skin surface defines a chamber, and said second opening is in communication therethrough with said pressure differential device, whereby operation of said pressure differential device causes an oscillating pressure to be produced within said chamber which causes said skin to vibrate; and wherein the pressure differential device is operable to produce pressure oscillations at a selectable frequency.

2. The apparatus and method of body contouring and skin conditioning according to claim 1 wherein said frequency is selectable through use of a switch associated with the pressure differential device wherein the frequency is able to be altered between “slow” and “fast” settings.

3. The apparatus and method of body contouring and skin conditioning according to claim 2 wherein said “fast” setting reflects a frequency of approximately 300 pulses per minute and is adapted for superficial treatment of the skin.

4. The apparatus and method of body contouring and skin conditioning according to claim 2 wherein said “slow” setting reflects a frequency of approximately 200 pulses per minute and is adapted for deeper treatment of the skin.

5. The apparatus and method of body contouring and skin conditioning according to claim 1 wherein said pressure differential device is adapted for the treatment of medical conditions such as lymphoedema.

6. A method of body contouring and skin conditioning using a suction device having a plurality of cups and a pressure differential device configured to produce a pressure differential, the method characterized by the steps of:
placing said plurality of cups onto a skin surface, whereby an opening of each said cup contacts the skin surface thereby defining a chamber; operating the pressure differential device to create an oscillating pressure within said chamber thereby causing tissue layers to vibrate; and controlling the frequency of the pressure oscillations by selecting a frequency of the oscillations.

7. The method according to claim 6, wherein the frequency is able to be selected through use of a switch alternated between “slow” and “fast” settings.

8. The method as according to claim 7, wherein said “fast” setting reflects a frequency of approximately 300 pulses per minute and is adapted for superficial treatment of the skin.

9. The method according to claim 6, wherein said “slow” setting reflects a frequency of approximately 200 pulses per minute and is adapted for deeper treatment of the skin.

10. The method according to claim 6 wherein said method is used for treatment of medical conditions such as lymphoedema.
